(19) United States
(12) Patent Application Publication
(10) Pub. No.: US 2009/0199495 A1
(43) Pub. Date: Aug. 13, 2009

(54) WEATHERSTRIP FOR DOUBLE-HUNG WINDOW ASSEMBLY

(75) Inventors: Ray Garries, Fox Island, WA (US); Gary Brunold, Klamath Falls, OR (US); Chad Elbert, Bonanza, OR (US); Mark Joseph Strong, Klamath Falls, OR (US)

Correspondence Address: NELSON MULLINS RILEY & SCARBOROUGH, LLP, 1320 MAIN STREET, 17TH FLOOR, COLUMBIA, SC, 29201, US

(73) Assignee: JELD-WEN, INC., Klamath Falls, OR (US)

(21) Appl. No.: 12/369,967

(22) Filed: Feb. 12, 2009

Related U.S. Application Data
(60) Provisional application No. 61/028,069, filed on Feb. 12, 2008.

(51) Int. Cl. E06B 1/04; E06B 7/16; B21K 23/00

(52) U.S. Cl. 52/204.1; 49/475.1; 29/897

(57) ABSTRACT

A window frame for use in a window assembly with a sash, the sash having a top rail, a bottom rail, and a first and a second stile extending therebetween. The window frame includes a head member, a sill member, and a jamb extending between the head member and the sill member. The jamb defines a first slot that is parallel to a longitudinal axis of the jamb and is adapted to receive a first weatherstrip. The first slot is disposed adjacent a corner of the first stile and angled with respect to a front surface and a side surface of the first stile.

This application claims priority to U.S. Provisional Patent Application Ser. No. 61/028,069, filed Feb. 12, 2008, the entire disclosure of which is hereby incorporated by reference herein.

### FIELD OF THE INVENTION

The present invention relates generally to double-hung window assemblies. More particularly, the present invention relates to various configurations of weatherstrip material within a frame of a double-hung window assembly.

### BACKGROUND

Double-hung window assemblies are commonly used in residential and other structures. Double-hung window assemblies typically include a window frame and a pair of window sashes. The bottom sash may be positioned inwardly of the top sash so that the sashes overlap and can be slid vertically relative to one another along the jambs of the window frame. Window sashes can be made of wood, extruded plastic frame members or metal frame members joined at the corners, for example, to form a generally rectangular frame in which the glazing, or glass panel, is installed. The top and bottom sashes typically include weatherstrip material disposed along, and extending outwardly from, their members. The weatherstrips abut portions of the window frame, thereby reducing or preventing water infiltration between the sashes and the window frame. As well, various members of the window frame often include weatherstrips that make contact with the sash members.

Double-hung windows often include a locking mechanism located where the sashes meet when the window assembly is in a closed position. A latch mechanism is fixed on the top rail of the bottom sash and the corresponding latch-receiving mechanism is fixed on the bottom rail of the top sash. When the window sashes are in the closed position, the lock may be engaged to prevent movement of the sashes.

### SUMMARY

The present invention recognizes and addresses considerations of prior art constructions and methods. One embodiment of the present invention discloses a window frame for use in a window assembly comprising a sash slidably mounted in the window frame, the sash comprising a top rail, a bottom rail, and a first and second stile extending therebetween. The window frame comprises a head member, a sill member, and a jamb extending between the head member and the sill member such that the jamb is transverse to both the head member and the sill member. The jamb defines a first slot that is parallel to a longitudinal axis of the jamb and is adapted to receive a first weatherstrip therein. The first slot is disposed adjacent a corner of the first stile of the sash and is angled with respect to a front surface and a side surface of the first stile.

Another embodiment of the present invention discloses a window assembly comprising a sash comprising a top rail, a bottom rail, and a first and a second stile extending therebetween, and a window frame comprising a head member, a sill member, a jamb extending between the head member and the sill member such that the jamb is transverse to both the head member and the sill member. The jamb defines a first slot that is parallel to a longitudinal axis of the jamb and is adapted to receive a first weatherstrip therein. The first slot is disposed adjacent a corner of the first stile of the sash and angled with respect to a front surface and a side surface of the first stile. The first weatherstrip is disposed in the first slot of the jamb, and the first weatherstrip contacts the front surface and the side surface of the first stile.

Yet another embodiment of the present invention discloses a method of making a window frame for use in a window assembly comprising a sash slidably mounted in the window frame, the sash comprising a top rail, a bottom rail, and a first and a second stile extending therebetween. The method comprises providing a head member, a sill member, and a jamb extending between the head member and the sill member such that the jamb is transverse to both the head member and the sill member. The jamb defines a first slot that is parallel to a longitudinal axis of the jamb and is adapted to receive a first weatherstrip therein. The first slot is disposed adjacent a corner of the first stile of the sash and is angled with respect to a front surface and a side surface of the first stile.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1A is a vertical, cross-sectional view of prior art head and sill members;

FIGS. 1B and 1C are vertical, cross-sectional views of a prior art window assembly including the prior art head and sill members shown in FIG. 1A;

FIG. 1D is a horizontal, cross-sectional view of a prior art window assembly;

FIG. 2 is a partially exploded perspective view of a preferred embodiment of a window assembly including a head member and a sill member in accordance with the present invention;

FIG. 3 is a perspective view of the window assembly as shown in FIG. 2;

FIG. 4A is a vertical, partial cross-sectional view of the window assembly as shown in FIG. 3, showing a head member and a sill member in accordance with the present invention;

FIGS. 4B and 4C are vertical, partial cross-sectional views of the window assembly as shown in FIG. 3, taken along line 4B-4B, showing the window assembly in the fully closed and fully open positions, respectively;

FIGS. 4D and 4E are horizontal, partial cross-sectional views of the window assembly as shown in FIG. 3, taken along lines 4D-4D and 4E-4E, respectively; and

FIG. 4F is a vertical, cross-sectional view of an alternate embodiment of a window in accordance with the present invention.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

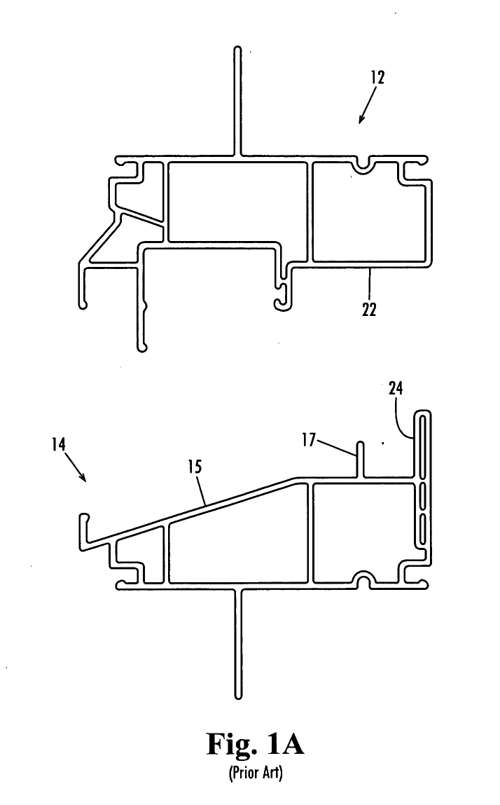

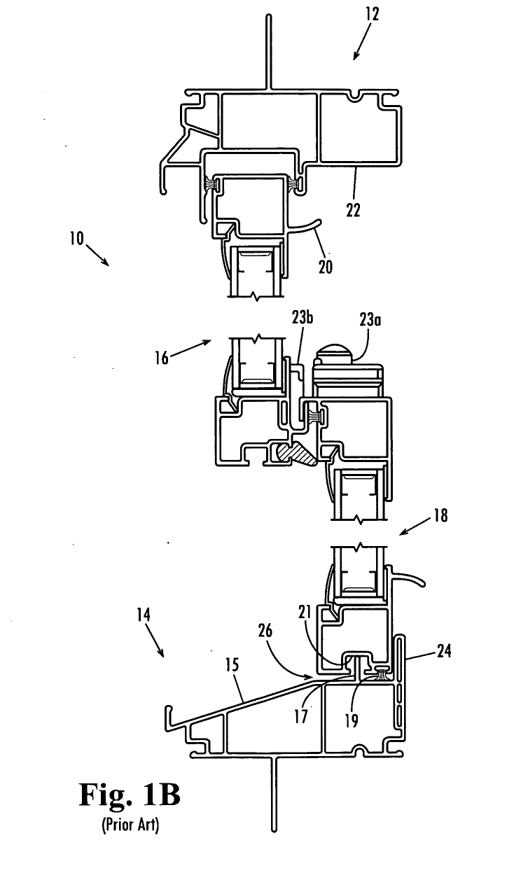

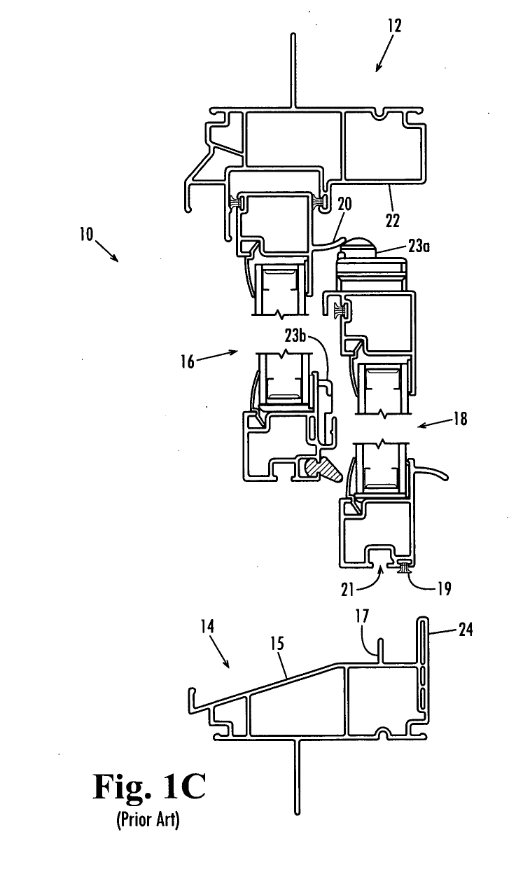

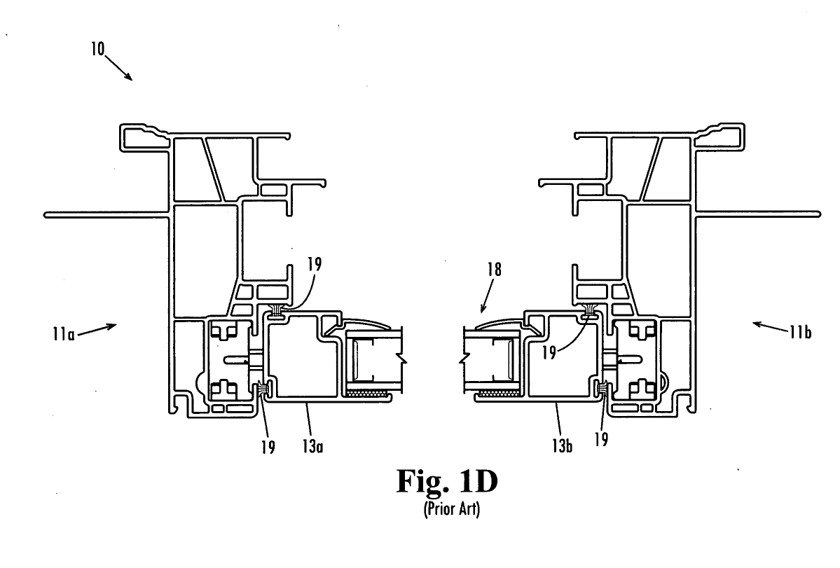

Referring now to FIGS. 1A through 1D, cross-sectional views of a prior art double-hung window assembly 10 are shown. Window assembly 10 includes a frame with a head member 12, a sill member 14, and a pair of jambs 11a and 11b extending therebetween (not shown), and a top sash 16 and a bottom sash 18 slidably mounted therein. As shown, a lock assembly latch 23a is disposed on the top rail of bottom sash 18 and a lock assembly receiver 23b is disposed on the bottom rail of top sash 16, and can be used to secure top sash 16 and bottom sash 18 in the closed position.

Prior art sill member 14 limits water intrusion by inhibiting the passage of water between the bottom rail of bottom sash 18 and sill member 14, resulting in the repelled water flowing down along a top surface 15 of sill member 14. To achieve this, typical prior art sill members may include structures such as a vertical fin 17 that extends into a recessed groove 21 formed in the bottom surface of the bottom rail of bottom sash 18. Additionally, weatherstripping 19 is typically provided that extends from the bottom surface of bottom sash 18 such that it contacts an upper surface of sill member 14 when bottom sash 18 is in the closed position.

As best seen in FIG. 1B, tolerance variations between bottom sash 18 and sill member 14 can lead to variations in a gap 26 defined by the these two elements. Moreover, because bottom sash 18 partially supports top sash 16 within the window frame, existing configurations can lead to minor bowing of bottom sash 18, which in turn can lead to variations in gap 26 between bottom sash 18 and sill member 14. As gap 26 varies, weatherstrip 19 that is disposed along the bottom edge of bottom sash 18 can lose contact with the top surface of sill member 14. Additionally, variations in gap 26 can prevent fin 17 from extending fully into recessed groove 21 of bottom sash 18. As such, the ability to prevent water intrusion through gap 26 can be adversely affected. The bowing of various window components noted above can also lead to gaps forming between the bottom rail of bottom sash 18 and interior wall 24 of sill member 14, which also adversely effects the prevention of water infiltration.

Additionally, as best seen in FIG. 1D, bowing can cause gaps to develop between stiles 13a and 13b of bottom sash 18 and jambs 11a and 11b of the window frame, which can also degrade performance of the window assembly. More specifically, bowing of bottom sash 18 can lead to the various weatherstrips 19 that are disposed along stiles 13a and 13b to break contact with the corresponding jambs 11a and 11b of the window frame. As would be expected, this can lead to moisture passing directly between stiles 13a and 13b and the corresponding jambs 11a and 11b, as well as increased collection of moisture on the top of sill member 14.

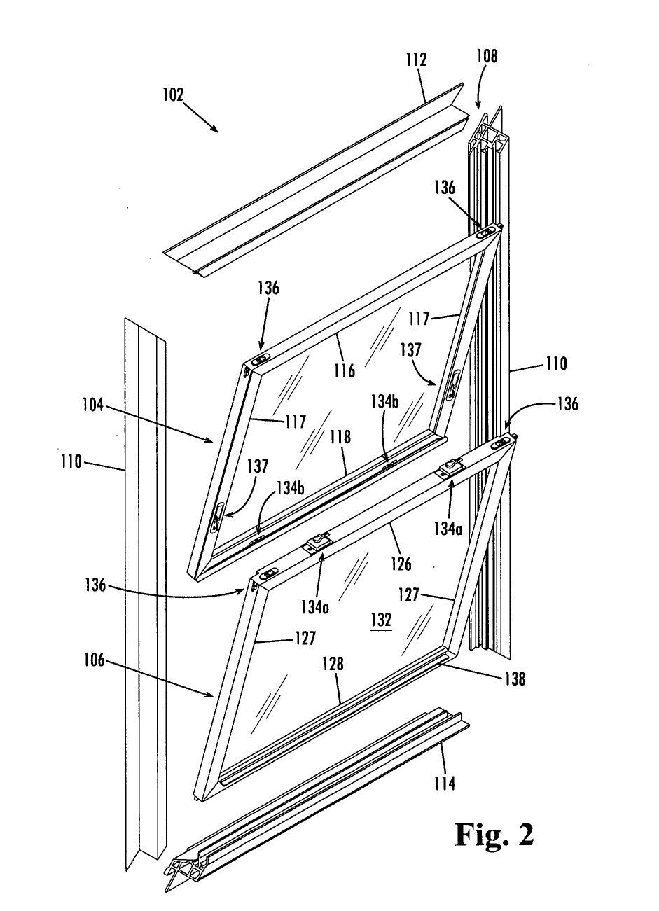

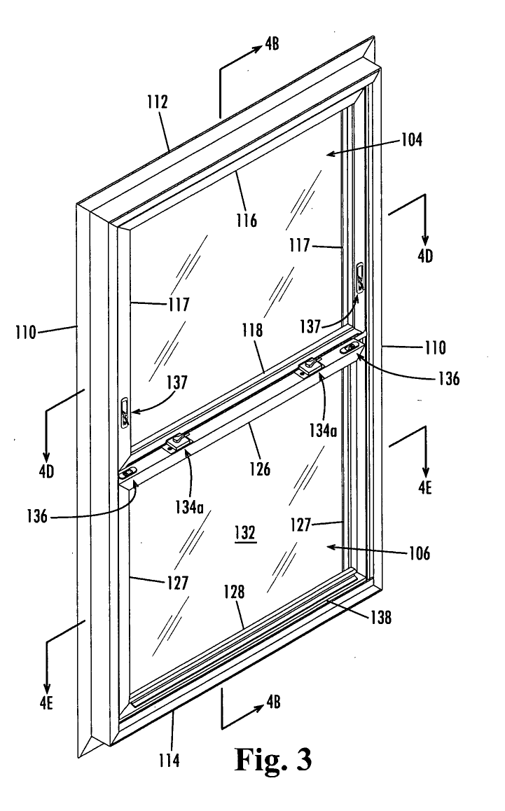

Referring now to FIGS. 2 and 3, a preferred embodiment of a double-hung window assembly 102 in accordance with the present invention is shown. Window assembly 102 includes a top sash 104 and a bottom sash 106 slidably received within frame 108. Frame 108 includes a pair of jambs 110 extending between a head member 112 and a sill member 114. Bottom sash 106 is positioned inwardly of top sash 104 so that sashes 104 and 106 can be slid vertically relative to each other within frame 108. Lock assembly latches 134a and lock assembly receivers 134b are positioned on a top rail 126 of bottom sash 106 and a bottom rail 118 of top sash 104, respectively, so that movement of sashes 104 and 106 within frame 108 can be prevented when sashes 104 and 106 are in their closed positions. Tilt latches 136 are mounted at the opposite ends of the top rails 116 and 126 of each sash. Disengaging tilt latches 136 from jambs 110 of frame 108 allows the respective sash to be tilted outwardly from the frame 108. A lift latch 137 is mounted in each stile 117 of top sash 104 and can be either extended to limit the amount of sliding motion between top and bottom sashes 104 and 106 or retracted to permit full sliding motion. As shown, a grasping fin 138 extends inwardly from bottom rail 128 of bottom sash 106 to facilitate opening and closing bottom sash 106, and a pair of stiles 127 extend-between top rail 126 and bottom rail 128.

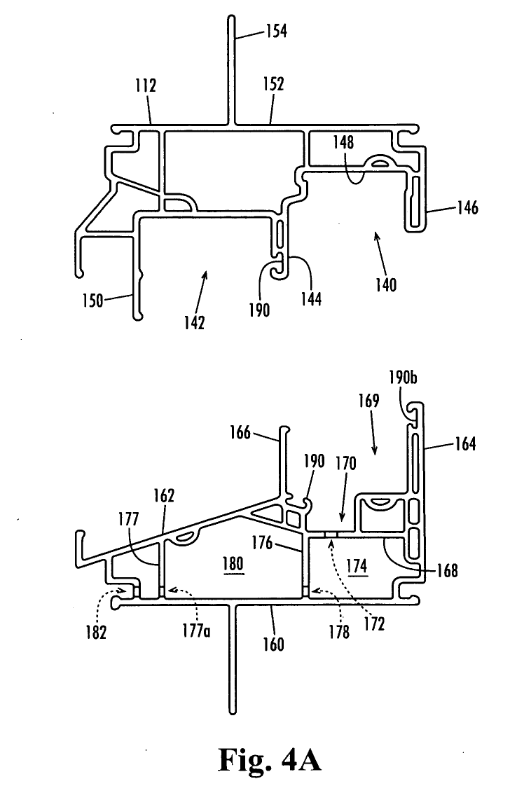

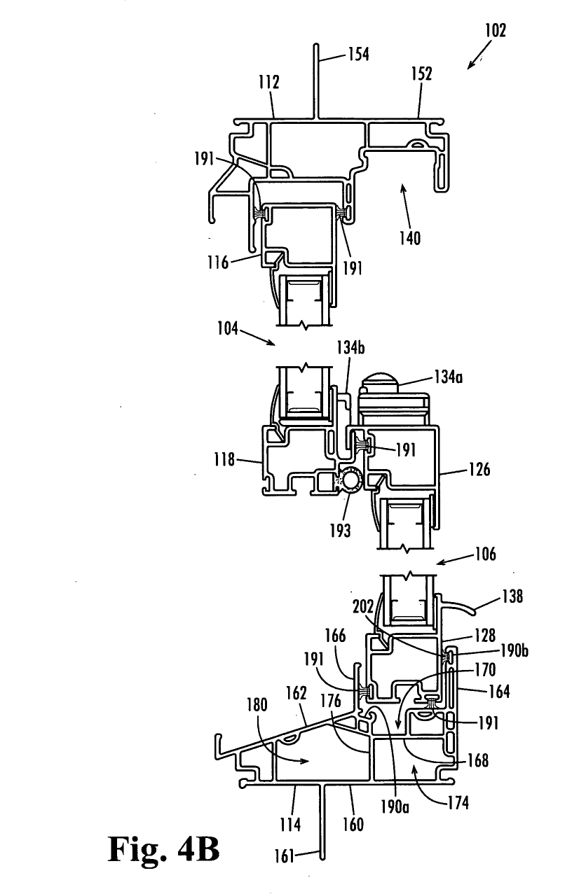

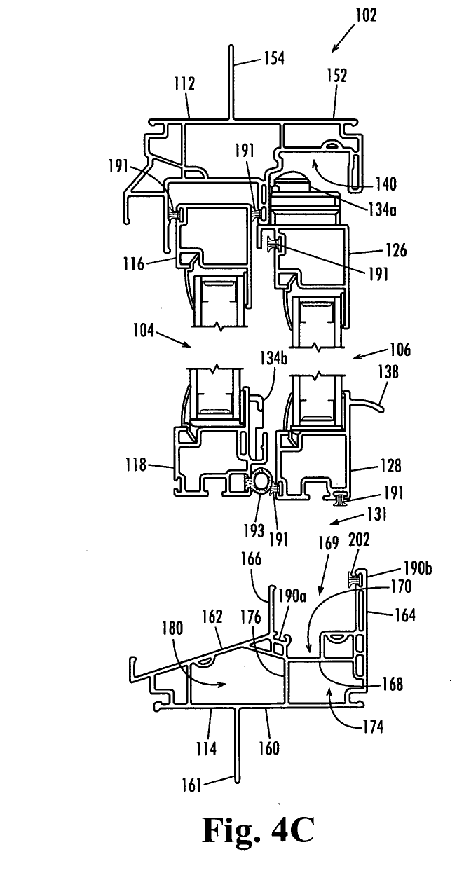

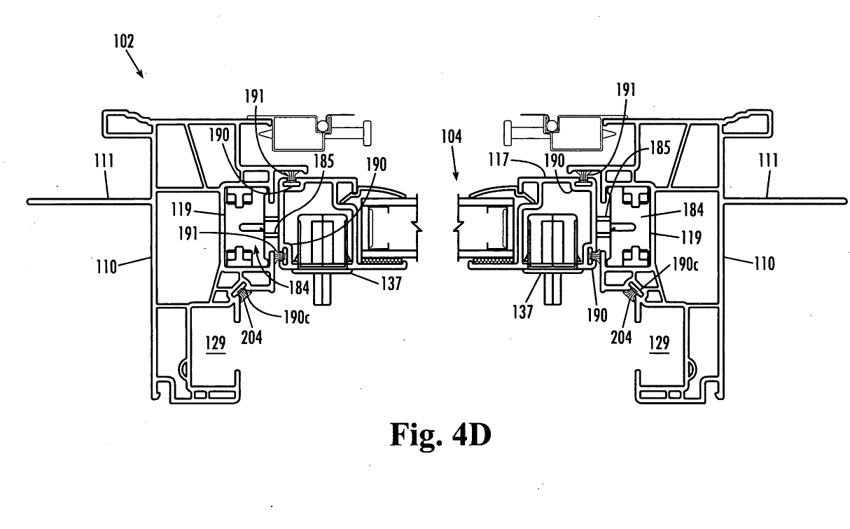

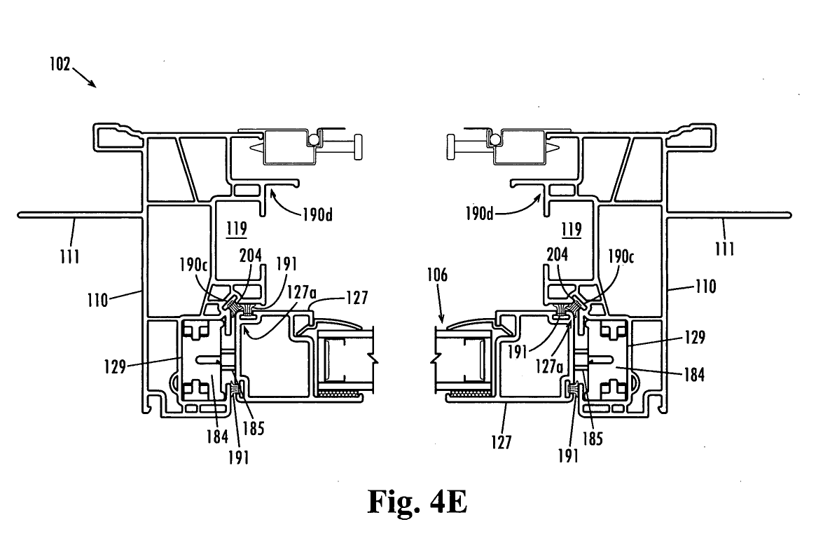

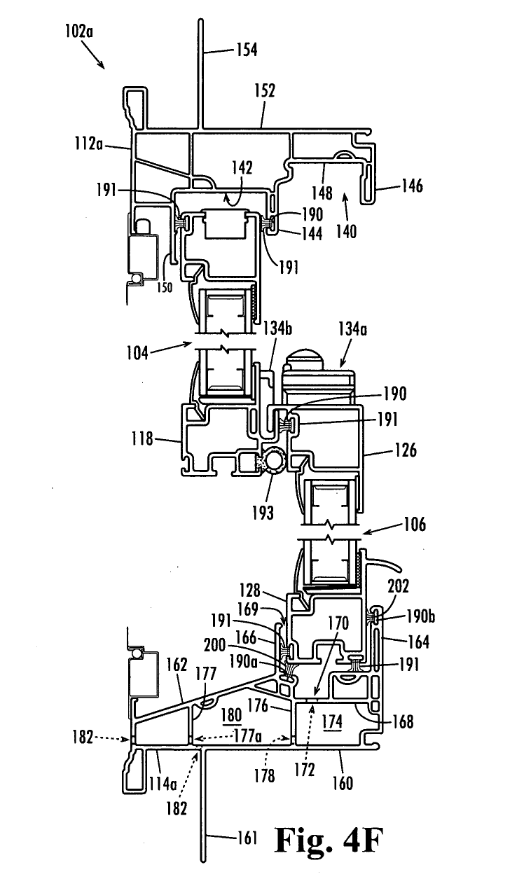

Referring now to FIGS. 4A through 4C and FIG. 4F, preferred embodiments of head members 112 and 112a, in accordance with the present invention, are shown. For the most part, head members 112 and 112a are similarly constructed. Therefore, for ease of description, only head member 112 is discussed. Head member 112 includes an inner channel 140 and an outer channel 142. Inner channel 140 is defined by front wall 144, back wall 146 and top wall 148. As best seen in FIG. 4B, inner channel 140 is configured to slidably receive lock mechanism 134a of bottom sash 106 when bottom sash 106 is placed in the fully open position. Note, as compared to prior art configurations as shown in FIG. 1C, inner channel 140 permits lock mechanism 134a to extend upwardly into head member 112 such that an opening 131 between bottom sash 106 and sill member 114 is maximized. Outer channel 142 is defined by front wall 144 and exterior wall 150, and is configured to slidably receive top rail 116 of top sash 104. A nailing fin 154 extends outwardly from top wall 152 for securing window frame 108 (FIGS. 2 and 3) to a building structure (not shown). As well, head member 112 includes a slot 190 for the positioning of weatherstrip material within head member 112. As shown, weatherstrip 191 received in slot 190 is fin-type weatherstrip material (such as that available from Amesbury Group (www.amesbury.com)). As well, a bulb-type weatherstrip 193 (also available from Amesbury Group) is received in the bottom rail of top sash 104 for making contact with the top rail of bottom sash 106, when in the closed position. Fin and bulb type weatherstrip materials are preferred for the present embodiment for their ability to limit air, water and particulate infiltration into the window assembly. Other weatherstrip materials and designs may be suitable.

Preferred embodiments of sill members 114 and 114a, in accordance with the present invention, are also shown in FIGS. 4A through 4C and FIG. 4F, respectively. For the most part, sill members 114 and 114a are similarly constructed. As such, for ease of description, only sill member 114 is discussed. Sill member 114 includes a bottom wall 160, a top wall 162, and a channel 169 defined by an interior wall 164, an exterior leg 166 and a floor 168. As best seen in FIG. 4B, channel 169 is configured to slidably receive bottom rail 128 of bottom sash 106. Sill member 114 also defines a first pocket 174 and a second pocket 180 that are divided by partition wall 176. As well, floor 168 of channel 169 further defines a trough 170 that extends the length of channel 169. Trough 170 is disposed above first pocket 174 and is configured such that any water infiltration between exterior leg 166 and bottom rail 128 of bottom sash 106 collects in trough 170 rather than moving to interior wall 164.

Sill member 114 includes a first slot 190a and a second slot 190b for receiving weatherstrip material. As shown, weatherstrip 202 is a fin-type weatherstrip material and helps to prevent water infiltration at elevated differential pressures across window assembly 102, as compared to prior art configurations. In the embodiment shown, weatherstrip material is not disposed in first slot 190a. However, as discussed in greater detail below with regard to FIG. 4F, a weatherstrip 204 can be positioned in first slot 190.

Referring now to FIGS. 4D and 4E, preferred embodiments of jambs 110, in accordance with the present invention are shown. As shown in FIG. 4D, top sash 104 is slidably received in a pair of channels 119 defined in jambs 110. Each channel 119 slidably receives a shoe 184 that is connected to sash 104 by a respective pivot bar 185. Each stile 117 of top sash 104 defines a pair of slots 190 for receiving weatherstrip material. As shown, weatherstrips 191 are fin-type weatherstrip material and each weatherstrip is sized to contact an inner surface of the respective jamb 110. Each jamb includes a nailing fin 111 for securing window frame 108 (FIGS. 2 and 3) to a building structure (not shown).

As shown in FIG. 4E, bottom sash 106 is slidably received in a pair of channels 129 defined in jambs 110. Each channel 129 slidably receives a shoe 184 that is connected to sash 106 by a respective pivot bar 185. Each stile 127 of bottom sash 106 defines a pair of slots 190 for receiving weatherstrip material. As shown, weatherstrips 191 are fin-type weatherstrip material and each weatherstrip is sized to contact an inner surface of the respective jamb 110. Each jamb 110 also defines a third slot 190c that slidably receives a weatherstrip 204 comprising a fin-type weatherstrip material. As shown, each third slot 190c is disposed adjacent a front, outer corner 127a of a respective stile 127 of bottom sash 106 and is angled at approximately 45° relative to the front surface of the respective stile 127. As such, each weatherstrip 204 makes contact with corner 127a of the respective stile 127 such that it contacts both the front surface and side surface of the stile 127. As such, weatherstrips 204 enhance the window assembly's ability to repel or redirect water as compared to prior art configurations by maintaining contact with stiles 127 even when bowing of bottom sash 106 may be present.

Referring now to FIG. 4F, an alternate embodiment of a sill member in accordance with the present invention is shown. Sill member 114a is similar to sill member 114, as shown in FIGS. 4A through 4C, with the exception that a weatherstrip 200 comprised of a fin-type weatherstrip material is disposed in first slot 190a. First slot 190a is disposed adjacent the bottom front corner of bottom rail 128 of bottom sash 106 and is at an angle with regard to the front surface of bottom rail 128. As such, weatherstrip 200 makes contact with the corner of bottom rail 128 such that it contacts both the front surface and bottom surface of the bottom rail 128 when bottom sash 106 is in the closed position. As such, weatherstrip 200 is a barrier to water infiltration even if bowing of bottom sash 106 is present.

As best seen in FIG. 4F, channel 169 of sill member 114a fully receives bottom rail 128 of bottom sash 106, which is in contrast to prior art sill members 14, such as those shown in FIGS. 1A through 1C. In prior art construction, the exterior portion of the bottom rail is exposed to the elements, which can lead to increased water infiltration. In contrast, water that may happen to pass between bottom rail 128 of bottom sash 106 and exterior leg 166 of sill member 114 collects in trough 170 rather than reaching interior wall 164. Also note, unlike prior art configurations, weatherstrip 202 on interior wall 164 further prevents water infiltration. One or more apertures 172 are defined in floor 168 of trough 170 such that any water that enters trough 170 is allowed to drain into first pocket 174. Similarly, water that enters first pocket 174 eventually passes through apertures 178 formed in partition wall 176 and it enters second pocket 180 of sill member 114, which it exits by passing through apertures 177a formed in a second partition wall 177. Ultimately, water passes out of sill member 114 through one or more apertures 182 defined in the front face of sill member 114. Note, apertures 182 are positioned on the exterior side of a nailing fin 161 such that any water passing through apertures 182 is directed away from the exterior of the building structure in which window assembly 102 is mounted.

Note, the disclosed head member 112 and sill member 114 combination allows for both increased performance with regard to preventing water infiltration at increased differential pressures across the window assembly while increasing the area of an egress opening as compared to the prior art. More specifically, as best seen in FIG. 3B, the configuration of inner channel 140 allows bottom sash 106 to be more fully opened than prior art configurations. As such, the dimensions of opening 131 can still be increased even though the height of interior wall 164 of sill member 114 has been increased to improve performance with regard to preventing water intrusion. As previously noted, increasing the area of opening 131 allows window assemblies 102 in accordance with the present invention to comply with egress and building codes while exhibiting improved performance with respect to reducing or eliminating the potential for water infiltration.

While one or more preferred embodiments of the invention are described above, it should be appreciated by those skilled in the art that various modifications and variations can be made in the present invention without departing from the scope and spirit thereof.

What is claimed:

1. A window frame for use in a window assembly comprising a sash slidably mounted in the window frame, the sash comprising a top rail, a bottom rail, and a first and a second stile extending therebetween, the window frame comprising:
a head member;
a sill member; and
a jamb extending between the head member and the sill member such that the jamb is transverse to both the head member and the sill member, the jamb defining a first slot that is parallel to a longitudinal axis of the jamb and is adapted to receive a first weatherstrip therein, the first slot being disposed adjacent a corner of the first stile of the sash and is angled with respect to a front surface and a side surface of the first stile.

2. The window frame of claim 1, wherein the first weatherstrip is disposed in the first slot of the jamb, and the first weatherstrip contacts the front surface and the side surface of the first stile.

3. The window frame of claim 2, wherein the first slot defined by the jamb forms a 45° angle with each of the front surface of the first stile and the side surface of the first stile.

4. The window frame of claim 2, wherein the weatherstrip makes contact with the corner of the first stile at which the front surface and side surface meet.

5. The window frame of claim 1, the sill member further comprising an interior wall extending upwardly from a top surface of the sill member, the interior wall defining a second slot that is parallel to a longitudinal axis of the sill member, and a second weatherstrip disposed in the first slot of the sill member such that the second weatherstrip contacts an inner surface of the bottom rail of the sash.

6. The window frame of claim 1, wherein the first weatherstrip comprises a fin-type weatherstrip.

7. The window frame of claim 1, the sill member further comprising a third slot that is parallel to a longitudinal axis of the sill member, and a third weatherstrip disposed in the third slot of the sill member such that the third weatherstrip contacts a front surface and a bottom surface of the bottom rail of the sash when the sash is in a closed position.

8. The window frame of claim 7, wherein the third slot is angled with respect to both the front surface and the bottom surface of the bottom rail of the sash.

9. A window assembly comprising:
a sash slidably comprising a top rail, a bottom rail, and a first and a second stile extending therebetween;
a window frame comprising:
a head member;
a sill member; and
a jamb extending between the head member and the sill member such that the jamb is transverse to both the head member and the sill member, the jamb defining a first slot that is parallel to a longitudinal axis of the jamb and is adapted to receive a first weatherstrip therein, the first slot being disposed adjacent a corner of the first stile of the sash and angled with respect to a front surface and a side surface of the first stile,
wherein the first weatherstrip is disposed in the first slot of the jamb, and the first weatherstrip contacts the front surface and the side surface of the first stile.

10. The window assembly of claim 9, wherein the first slot defined by the jamb forms a 45° angle with each of the front surface of the first stile and the side surface of the first stile.

11. The window assembly of claim 9, wherein the weatherstrip makes contact with the corner of the first stile at which the front surface and side surface meet.

12. The window assembly of claim 9, the sill member further comprising an interior wall extending upwardly from a top surface of the sill member, the interior wall defining a second slot that is parallel to a longitudinal axis of the sill member, and a second weatherstrip disposed in the first slot of the sill member such that the second weatherstrip contacts an inner surface of the bottom rail of the sash.

13. The window assembly of claim 9, the sill member further comprising a third slot that is parallel to a longitudinal axis of the sill member and is angled with respect to both a front surface and a bottom surface of the bottom rail of the sash.

14. The window frame of claim 13, a third weatherstrip disposed in the third slot of the sill member such that the third weatherstrip contacts the front surface and the bottom surface of the bottom rail of the sash when the sash is in a closed position.

15. A method of making a window frame for use in a window assembly comprising a sash slidably mounted in the window frame, the sash comprising a top rail, a bottom rail, and a first and a second stile extending therebetween, the method comprising:
providing a head member;
providing a sill member; and
providing a jamb extending between the head member and the sill member such that the jamb is transverse to both the head member and the sill member, the jamb defining a first slot that is parallel to a longitudinal axis of the jamb and is adapted to receive a first weatherstrip therein, the first slot being disposed adjacent a corner of the first stile of the sash and is angled with respect to a front surface and a side surface of the first stile.
